(19) United States
(12) Patent Application Publication
(10) Pub. No.: US 2015/0280319 A1
(43) Pub. Date: Oct. 1, 2015

(54) FREQUENCY-SWITCHABLE ACTIVE ANTENNA SYSTEM AND CONTROL METHOD THEREOF

(71) Applicant: Ming-Hao Yeh, New Taipei City (TW)

(72) Inventor: Ming-Hao Yeh, New Taipei City (TW)

(21) Appl. No.: 14/311,959

(22) Filed: Jun. 23, 2014

(30) Foreign Application Priority Data
Mar. 28, 2014 (TW) 103111766

(51) Int. Cl. H01Q 3/00; H01Q 1/50

(52) U.S. Cl. CPC H01Q 3/00; H01Q 1/50

(57) ABSTRACT

An active antenna system includes a printed circuit board, an antenna radiation element, a metal ground surface, and a first switching circuit. The printed circuit board has an antenna clearance region. The antenna radiation element has a feed port, a first physical position and a second physical position. The metal ground surface is formed on a first layer of the printed circuit board and outside the antenna clearance region. A first terminal of the first switching circuit is connected to the first physical position. A second terminal of the first switching circuit is connected to the second physical position. A control terminal of the first switching circuit receives a control signal. The first physical position and the second physical position are selectively connected with each other or disconnected from each other according to the control signal.

This application claims the benefit of Taiwan Patent Application No. 103111766, filed Mar. 28, 2014, the subject matter of which is incorporated herein by reference.

### FIELD OF THE INVENTION

The present invention relates to an antenna system and a control method thereof, and more particularly to a frequency-switchable active antenna system and a control method thereof.

### BACKGROUND OF THE INVENTION

Generally, a single-fed passive antenna is widely used in a wireless consumer product. This type of antenna is simple in structure, easy to use, cost-effective and small-sized. This antenna has only a single feed port and is able to support all frequency bands of the communication system. For example, the antenna is a Bluetooth antenna, a WiFi antenna, a 2G mobile antenna or a 3G mobile antenna. Generally, the frequency bands of the 2G mobile antenna are in the range between 824 MHz and 960 MHz and in the range between 1710 MHz and 1990 MHz. Moreover, the frequency band of the 3G mobile antenna is in the range between 1920 MHz and 2170 MHz (i.e. Band 1) attracts more attention. As a whole, the 2G/3G frequency bands cover a low frequency band (824 MHz˜960 MHz) and a high frequency band (1710 MHz˜2170 MHz).

With increasing development of the current global mobile communication technology, a fourth generation long term evolution (4G LTE) technology becomes more popular. In many areas of the world, the operation frequency band of the 4G mobile communication standard is wider than the 2G/3G operation frequency band. Especially, the 700 MHz frequency band (Band 13 and Band 17 in USA) and the 2300-2620 MHz frequency band (Band 38 and Band 40 in China) attract intensive attention.

It is difficult for allowing the 4G mobile antenna to simultaneously support the existing 2G/3G frequency bands and the advanced 4G frequency band. Recently, the integration level of the functions of the mobile phone is gradually increased, and the thickness of mobile phone is gradually decreased. Consequently, the inner space of the mobile phone for accommodating the antenna is gradually restricted. Due to these reasons, it is more difficult to design the 4G mobile antenna.

FIG. 1A schematically illustrates the configurations of a conventional single-fed 4G passive antenna. FIG. 1B schematically illustrates the dimensions of a radiation element of the antenna of FIG. 1A. FIG. 1C schematically illustrates the relationship between the measured return loss and the frequency bandwidth of the antenna of FIG. 1A. The information about this antenna is published in IEEE Transactions on Antennas and Propagation, Vol. 59, NO. 11, November 2011 page 4215-4221 and entitled “Internal Coupled-Fed Dual-loop Antenna Integrated with a USB Connector for WWAN/LTE Mobile Handset”.

As shown in FIG. 1A, the antenna is formed on a printed circuit board (PCB), which is made of FR4 material. The printed circuit board has an overall length of 115 mm and an overall width of 55 mm. A metal ground surface 130 corresponding to the antenna has a length of 105 mm and a width of 55 mm. The width w of an antenna clearance region is 10 mm. The length of the antenna clearance region is equal to the width of the printed circuit board (i.e. 55 mm). A radiation element 120 of the antenna is included in the antenna clearance region.

As shown in FIG. 1B, the point A is the only feed port of the radiation element 120, and the point B is the only ground terminal of the radiation element 120. Moreover, the metal ground surface 130 is formed on the bottom layer of the FR4 printed circuit board. Both of the radiation element 120 and the feed port A are formed on a top layer of the FR4 printed circuit board. The radiation element 120 is directly connected with the metal ground surface 130 at the point B′ through a via.

Generally, a larger width w of the antenna clearance region is beneficial to the antenna design and the antenna property. In views of the product design, the antenna has to be installed within a case of the mobile phone. However, since the width w of the antenna clearance region is larger, the outer appearance of the mobile phone is highly dependent on the antenna clearance region. Especially, the length of the mobile phone is influenced by the larger width w of the antenna clearance region. On the other hand, since the systematic integration of the inner circuitry of the mobile phone is very high, the mobile phone has no enough inner space for accommodating the antenna. Moreover, since the width w of the antenna clearance region is 10 mm, this dimension is too large to design the modern mobile phone.

The result of the measured return loss of FIG. 10 is based on a bandwidth definition of a voltage standing wave ratio (VSWR)=3:1 (i.e. −6 dB return loss). Consequently, the antenna bandwidth covers the frequency band BW_a (700 MHz-1170 MHz) and the frequency band BW_b (1705 MHz-2740 MHz).

However, in designing the antenna of the mobile phone, the integration between the antenna and the circuitry system should be taken into consideration. That is, the matching between the power amplifier (PA) and the low noise amplifier (LNA) of the circuitry system and the antenna is an important factor of designing the antenna. Consequently, the result of the measured return loss is based on the bandwidth definition of VSWR=2:1 (i.e. −10 dB return loss). That is, the standard of the antenna becomes more stringent. Consequently, after the antenna is integrated into the circuitry system, the performance is optimized. According to the bandwidth definition of VSWR=2:1, the antenna bandwidth covers the frequency band BW_c (725 MHz-800 MHz) and the frequency band BW_d (1900 MHz-2700 MHz). In other words, the antenna bandwidth is narrowed. As shown in FIG. 10, the frequency band BW_c (725 MHz-800 MHz) and the frequency band BW_d (1900 MHz-2700 MHz) cannot cover all 2G/3G/4G frequency bands. In fact, the antenna bandwidth fails to meet the antenna design requirements of the mobile phone.

FIG. 2A schematically illustrates the configurations of another conventional single-fed 4G passive antenna. FIG. 2B schematically illustrates the dimensions of a radiation element of the antenna of FIG. 2A. FIG. 2C schematically illustrates the relationship between the measured return loss and the frequency bandwidth of the antenna of FIG. 2A. The information about this antenna is published in Antennas and Propagation Society Internal Symposium (APSURSI), 2010 IEEE, Conference date 11-17 Jul. 2010 (Toronto) and entitled “Internal Small-size PIFA for LTE/GSM/UMTS Operation in Mobile Phone”.

As shown in FIG. 2A, the antenna is formed on a printed circuit board (PCB), which is made of FR4 material. The printed circuit board has an overall length of 115 mm and an overall width of 45 mm. A metal ground surface 230 corresponding to the antenna has a length of 100 mm and a width of 45 mm. The width w of an antenna clearance region is 15 mm. The length of the antenna clearance region is equal to the width of the printed circuit board (i.e. 45 mm). A radiation element 220 of the antenna is included in the antenna clearance region.

As shown in FIG. 2B, the point A is the only feed port of the radiation element 220, and the point B is the only ground terminal of the radiation element 220. Moreover, the metal ground surface 230 is formed on the bottom layer of the FR4 printed circuit board. Both of the radiation element 220 and the feed port A are formed on a top layer of the FR4 printed circuit board. The radiation element 220 is directly connected with the metal ground surface 230 at the point B through a via. Obviously, since the width w of the antenna clearance region is 15 mm, this dimension is too large to design the modern mobile phone.

The result of the measured return loss of FIG. 2C is based on a bandwidth definition of a voltage standing wave ratio (VSWR)=3:1 (i.e. −6 dB return loss). Consequently, the antenna bandwidth covers the frequency band BW_a (695 MHz-1040 MHz) and the frequency band BW_b (1580 MHz-2840 MHz). Similarly, according to the bandwidth definition of VSWR=2:1, the antenna bandwidth covers four small frequency bands BW_c (700 MHz-775 MHz), BW_d (1750 MHz-1950 MHz), BW_e (2100 MHz-2250 MHz) and BW_f (2650 MHz-2800 MHz). In other words, the antenna bandwidth is narrowed. In fact, the antenna bandwidth still fails to meet the antenna design requirements of the mobile phone.

FIG. 3A schematically illustrates the configurations of another conventional single-fed 4G passive antenna. FIG. 3B schematically illustrates the dimensions of a radiation element of the antenna of FIG. 3A. FIG. 3C schematically illustrates the relationship between the measured return loss and the frequency bandwidth of the antenna of FIG. 3A. The information about this antenna is published in IEEE Transactions on Antennas and Propagation, Vol. 58, NO. 10, October 2010 page 3426-3431 and entitled “Planar Printed Strip Monopole With a Closely-Coupled Parasitic Shorted Strip For Eight-Band LTE/GSM/UMTS Mobile Phone”.

As shown in FIG. 3A, the antenna is formed on a printed circuit board (PCB), which is made of FR4 material. The printed circuit board has an overall length of 119 mm and an overall width of 64 mm. A metal ground surface 330 corresponding to the antenna has a length of 104 mm and a width of 64 mm. The width w of an antenna clearance region is 15 mm. The length of the antenna clearance region is equal to the width of the printed circuit board (i.e. 64 mm). A radiation element 320 of the antenna is included in the antenna clearance region.

As shown in FIG. 3B, the point A is the only feed port of the radiation element 320, and the point B is the only ground terminal of the radiation element 320. Moreover, the metal ground surface 330 is formed on the bottom layer of the FR4 printed circuit board. Both of the radiation element 320 and the feed port A are formed on a top layer of the FR4 printed circuit board. The radiation element 320 is directly connected with the metal ground surface 330 at the point B through a via. Obviously, since the width w of the antenna clearance region is 15 mm, this dimension is too large to design the modern mobile phone.

The result of the measured return loss is shown in FIG. 3C. It is found that the frequency bands of the antenna bandwidth fails to meet the standard of the bandwidth definition of VSWR=2:1.

Since the 4G mobile antenna has to support all of the 2G/3G/4G frequency bands, the 4G mobile antenna designed according to the concept of the single-fed 4G passive antenna has many disadvantages such as large size, poor antenna match or insufficient bandwidth.

For solving the above drawbacks, the concept of designing a single-fed active antenna has been applied to the 4G mobile antenna. Generally, a tunable capacitor module is widely used in an antenna matching circuit.

FIG. 4 is a schematic functional block diagram illustrating a conventional single-fed active antenna system. As shown in FIG. 4, the antenna system comprises a control chip 410, a control interface 420, a high voltage output capacitor controller 430, an antenna feed transmission line 450, a tunable capacitor module 460, and an antenna radiation element 470. The tunable capacitor module 460 is directly installed on the antenna feed transmission line 450 and used as a matching circuit of the antenna radiation element 470. A high voltage output signal 440 is outputted from the high voltage output capacitor controller 430. The magnitude of the high voltage output signal 440 is in the range between 0 and 30V for controlling the capacitance value of the variable capacitor of the tunable capacitor module 460.

When the mobile phone and the base station communicate with each other at a specified operation frequency, the antenna radiation element 470 has to match the specified operation frequency. For matching the specified operation frequency, the capacitance value of the tunable capacitor module 460 is set as a specified capacitance value. Consequently, through the control interface 420, the control chip 410 requests the high voltage output capacitor controller 430 to output the high voltage output signal 440. According to the high voltage output signal 440, the capacitance value of the tunable capacitor module 460 is adjusted to the specified capacitance value.

In the stages of designing the antenna system, various capacitance values of the tunable capacitor module 460 corresponding to plural operations frequencies are defined in advance, and these capacitance values are created as a database and stored in the memory of the mobile phone. In other words, the complexity of designing the antenna is increased.

Generally, the capacitance value of the tunable capacitor module 460 is usually lower than 10 pF. Moreover, the current technology is unable to integrate an inductor into the tunable capacitor module 460. Consequently, after the antenna radiation element 470 matches the tunable capacitor module 460, the dynamic range of the operation frequency of the antenna system is limited. However, by using this designing concept, it is difficult to have the antenna bandwidth cover all of the 2G/3G/4G frequency bands between 700 MHz (minimum) and 2620 MHz (maximum). For achieving the matching purpose, it is a challenge to design the matching circuit of the tunable capacitor module 460.

### SUMMARY OF THE INVENTION

An embodiment of the present invention provides an active antenna system. The active antenna system includes a printed circuit board, an antenna radiation element, a metal ground surface, and a first switching circuit. The printed circuit board has an antenna clearance region. The antenna radiation element has a feed port, a first physical position and a second physical position. The metal ground surface is formed on a first layer of the printed circuit board and outside the antenna clearance region. A first terminal of the first switching circuit is connected to the first physical position. A second terminal of the first switching circuit is connected to the second physical position. A control terminal of the first switching circuit receives a first control signal. The first physical position and the second physical position are selectively connected with each other or disconnected from each other according to the first control signal.

Another embodiment of the present invention provides a control method of an active antenna system. The active antenna system includes an antenna radiation element and a first switching circuit. The antenna radiation element has a feed port, a first physical position and a second physical position. A first terminal of the first switching circuit is connected to the first physical position. A second terminal of the first switching circuit is connected to the second physical position. The control method includes the following steps. Firstly, a control signal is provided to the first switching circuit. If the first physical position and the second physical position are not connected with each other through the first switching circuit according to the control signal, the antenna radiation element resonates at a first resonant frequency. If the first physical position and the second physical position are connected with each other through the first switching circuit according to the control signal, the antenna radiation element resonates at a second resonant frequency and a third resonant frequency. The second resonant frequency and the third resonant frequency are higher than the first resonant frequency.

A further embodiment of the present invention provides an active antenna system. The active antenna system includes a printed circuit board, an antenna radiation element, a conductor, a metal ground surface, a parasitic element, and a switching circuit. The printed circuit board has an antenna clearance region. The antenna radiation element includes a feed port, a first physical position and a second physical position. The conductor is connected to the first physical position. The metal ground surface is formed on a first layer of the printed circuit board and outside the antenna clearance region. The parasitic element has a third physical position. A first terminal of the switching circuit is connected to the third physical position. A second terminal of the switching circuit is connected to the second physical position. A third terminal of the switching circuit is connected to the metal ground surface. A control terminal of the switching circuit receives a control signal. According to the control signal, the third physical position and the second physical position are connected with each other through the switching circuit or the third physical position and the metal ground surface are connected with each other through the switching circuit.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A (prior art) schematically illustrates the configurations of a conventional single-fed 4G passive antenna;

FIG. 1B (prior art) schematically illustrates the dimensions of a radiation element of the antenna of FIG. 1A;

FIG. 1C (prior art) schematically illustrates the relationship between the measured return loss and the frequency bandwidth of the antenna of FIG. 1A;

FIG. 2A (prior art) schematically illustrates the configurations of another conventional single-fed 4G passive antenna;

FIG. 2B (prior art) schematically illustrates the dimensions of a radiation element of the antenna of FIG. 2A;

FIG. 2C (prior art) schematically illustrates the relationship between the measured return loss and the frequency bandwidth of the antenna of FIG. 2A;

FIG. 3A (prior art) schematically illustrates the configurations of another conventional single-fed 4G passive antenna;

FIG. 3B (prior art) schematically illustrates the dimensions of a radiation element of the antenna of FIG. 3A;

FIG. 3C (prior art) schematically illustrates the relationship between the measured return loss and the frequency bandwidth of the antenna of FIG. 3A;

FIG. 4 (prior art) is a schematic functional block diagram illustrating a conventional single-fed active antenna system;

FIG. 5A schematically illustrates the configurations of a frequency-switchable active antenna system according to a first embodiment of the present invention;

FIGS. 5B and 5C schematically illustrate two equivalent circuits of the frequency-switchable active antenna system of FIG. 5A in a normal working mode;

FIG. 5D schematically illustrates the relationship between the measured return loss and the frequency bandwidth of the frequency-switchable active antenna system of FIG. 5A;

FIG. 6A schematically illustrates the configurations of a frequency-switchable active antenna system according to a second embodiment of the present invention;

FIGS. 6B and 6C schematically illustrate two equivalent circuits of the frequency-switchable active antenna system of FIG. 6A in a normal working mode;

FIG. 6D schematically illustrates the relationship between the measured return loss and the frequency bandwidth of the frequency-switchable active antenna system of FIG. 6A;

FIGS. 7A and 7B schematically illustrates schematically illustrate two equivalent circuits of a frequency-switchable active antenna system in a normal working mode according to a third embodiment of the present invention; and

FIG. 7C schematically illustrates the relationship between the measured return loss and the frequency bandwidth of the frequency-switchable active antenna system of the third embodiment.

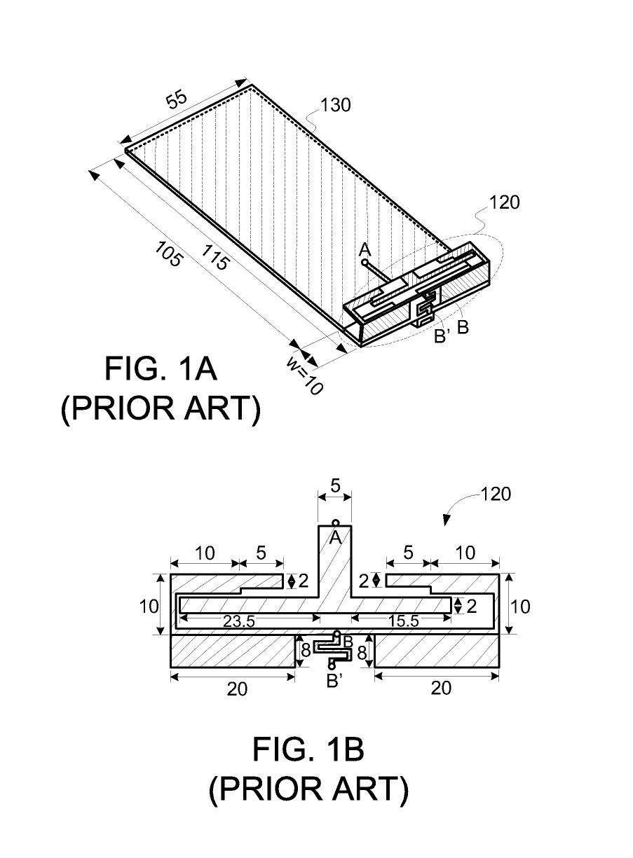

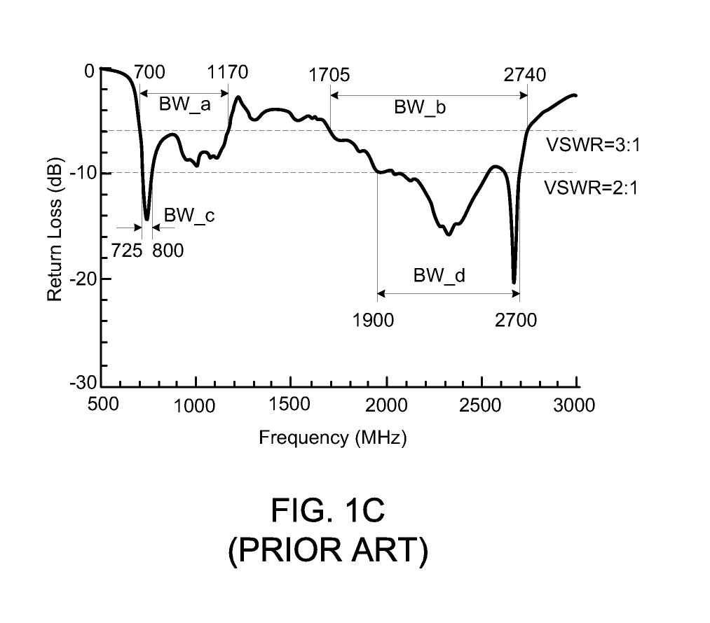

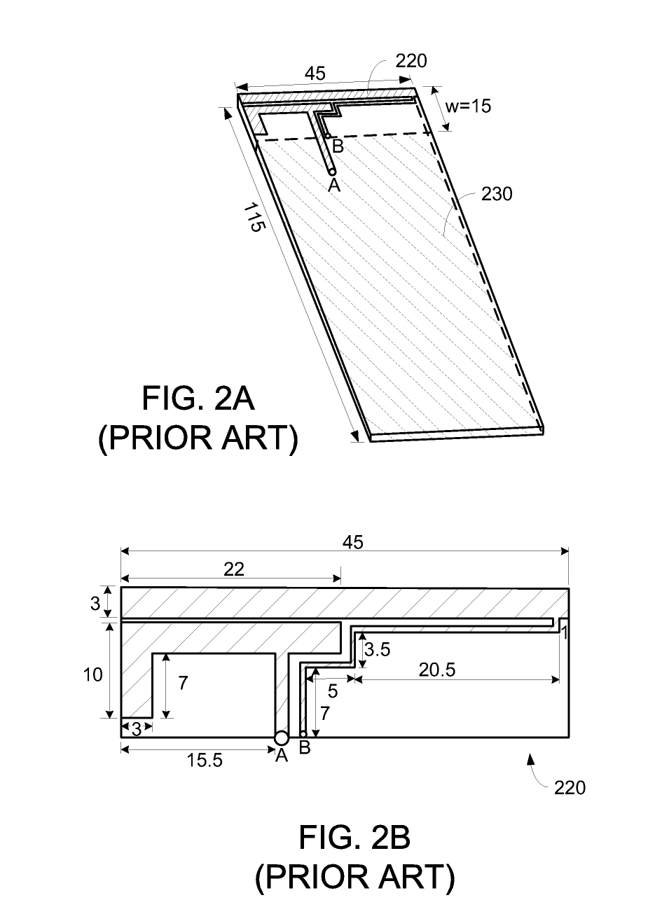

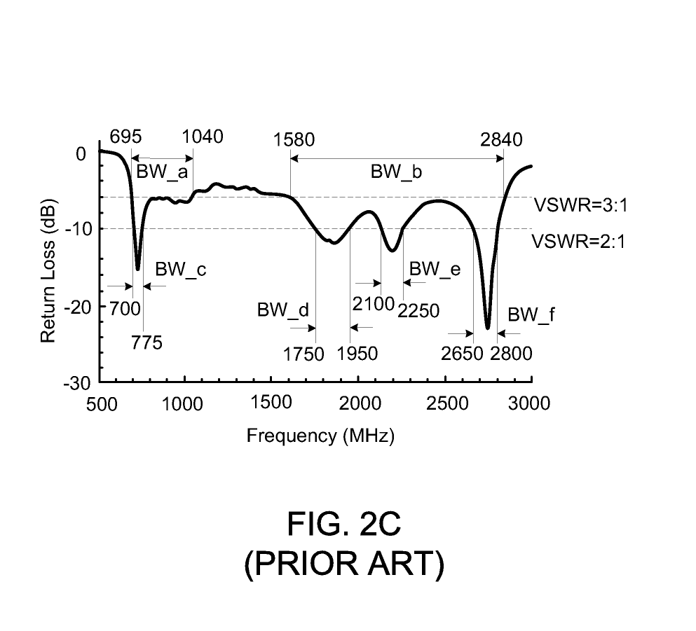

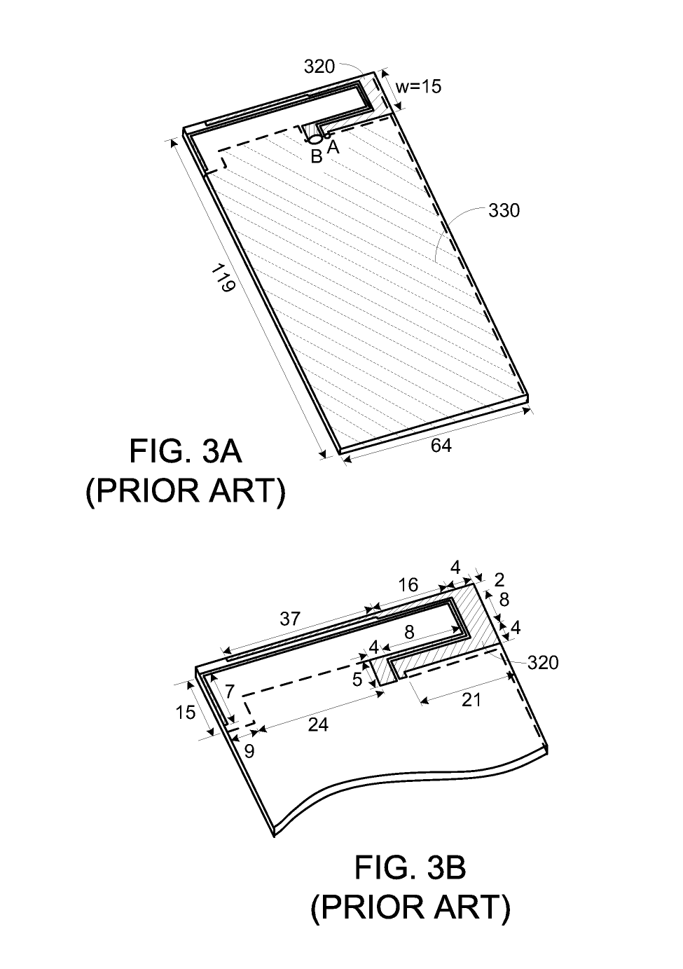

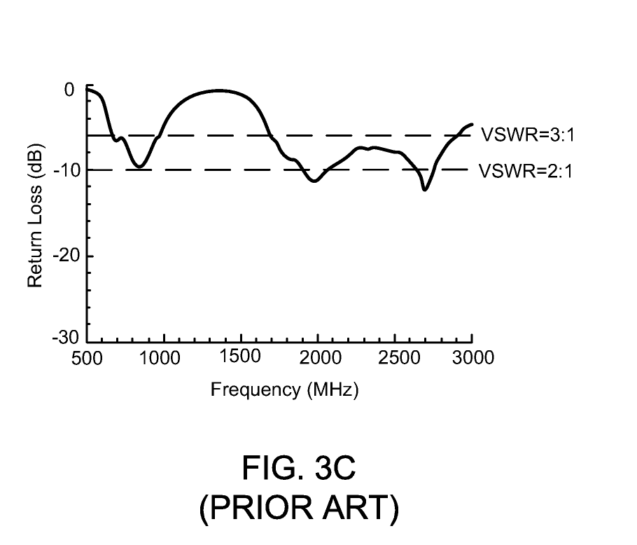

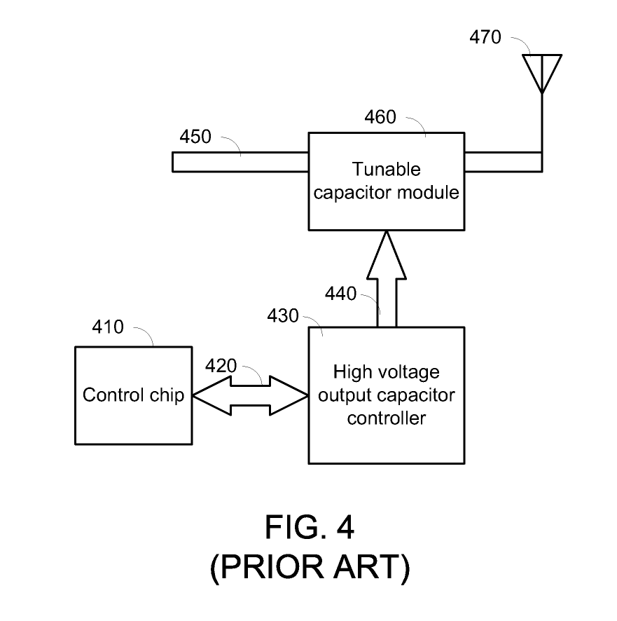

### DETAILED DESCRIPTION OF PREFERRED EMBODIMENTS

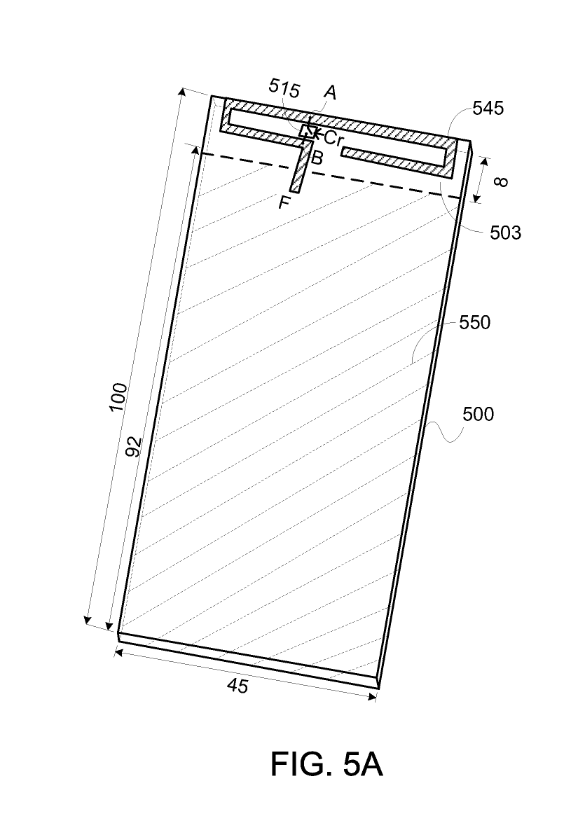

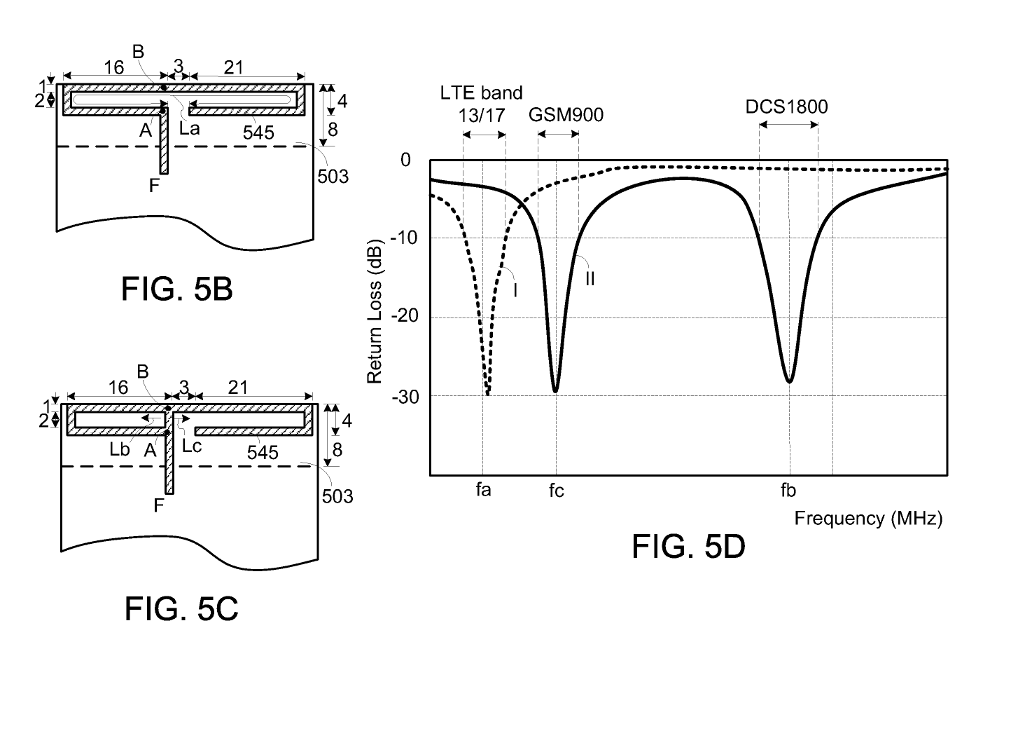

FIG. 5A schematically illustrates the configurations of a frequency-switchable active antenna system according to a first embodiment of the present invention. FIGS. 5B and 5C schematically illustrate two equivalent circuits of the frequency-switchable active antenna system of FIG. 5A in a normal working mode. FIG. 5D schematically illustrates the relationship between the measured return loss and the frequency bandwidth of the frequency-switchable active antenna system of FIG. 5A. The frequency-switchable active antenna system is formed on a printed circuit board 500. The printed circuit board 500 has a length of 100 mm and a width of 45 mm. The printed circuit board 500 has an antenna clearance region 503 with a length of 45 mm and a width of 8 mm. An antenna radiation element 545 is included in the antenna clearance region 503. The antenna radiation element 545 has a feed port at a position F. Moreover, a line width of the antenna radiation element 545 is 1 mm. The other dimensions will be illustrated with reference to FIGS. 5B and 5C.

The antenna radiation element 545 has two different physical positions A and B. The frequency-switchable active antenna system further comprises a switching circuit 515. A first terminal of the switching circuit 515 is connected with the physical position A. A second terminal of the switching circuit 515 is connected with the physical position B. Moreover, a control terminal of the switching circuit 515 receives a control signal Cr, so that the switching circuit 515 is controlled by the control signal Cr. According to the control signal Cr, the switching circuit 515 is selectively in an open state or a close state.

Moreover, a metal ground surface 550 is formed on a bottom layer (e.g. a first layer) of the printed circuit board 500 and outside the antenna clearance region 503. The metal ground surface 550 has a length of 92 mm and a width of 45 mm. The position F of the feed port is disposed on a top layer (e.g. a second layer) of the printed circuit board 500, and disposed over the metal ground surface 550.

In the frequency-switchable active antenna system of the first embodiment, the antenna radiation element 545 is not connected with the metal ground surface 550. Moreover, the switching circuit 515 may be selectively in the open state or the close state.

In the normal working mode of FIG. 5B, the switching circuit 515 is in the open state. Under this circumstance, the two physical positions A and B are not connected with each other through the switching circuit 515. Consequently, the radiation path length of the antenna radiation element 545 is equal to La. The dotted curve I of FIG. 5D denotes the result of the measured return loss of the antenna system in the normal working mode of FIG. 5B. That is, the radiation path length La resonates at a first resonant frequency fa.

In the normal working mode of FIG. 5C, the switching circuit 515 is in the close state. Under this circumstance, the two physical positions A and B are connected with each other through the switching circuit 515. The radiation path length at the left side of the feed port position F of the antenna radiation element 545 is equal to Lb, and the radiation path length at the right side of the feed port position F of the antenna radiation element 545 is equal to Lc. The solid curve II of FIG. 5D denotes the result of the measured return loss of the antenna system in the normal working mode of FIG. 5C. That is, the radiation path lengths Lb and Lc resonate at a second resonant frequency fb and a third resonant frequency fc, respectively.

After the switching circuit 515 is switched from the open state to the close state, the longer radiation path length La of the antenna radiation element 545 as shown in FIG. 5B is changed to two shorter radiation path lengths Lb and Lc. The radiation path length La resonates at the first resonant frequency fa. The radiation path length Lb resonates at the second resonant frequency fb. The radiation path length Lc resonates at the third resonant frequency fc.

From the above discussions about the first embodiment, the switching circuit 515 is selectively in the open state or the close state. When the switching circuit 515 is switched between the open state and the close state, the radiation path length of the antenna radiation element 545 is correspondingly changed. Consequently, the radiation path length of the antenna radiation element 545 resonates at the lower resonant frequency fa or at two higher resonant frequencies fb and fc.

Moreover, by properly adjusting the radiation path lengths La, Lb and Lc, the bandwidth of the antenna system may cover the three frequency bands LTE Band13/17, GSM900 and DCS1800.

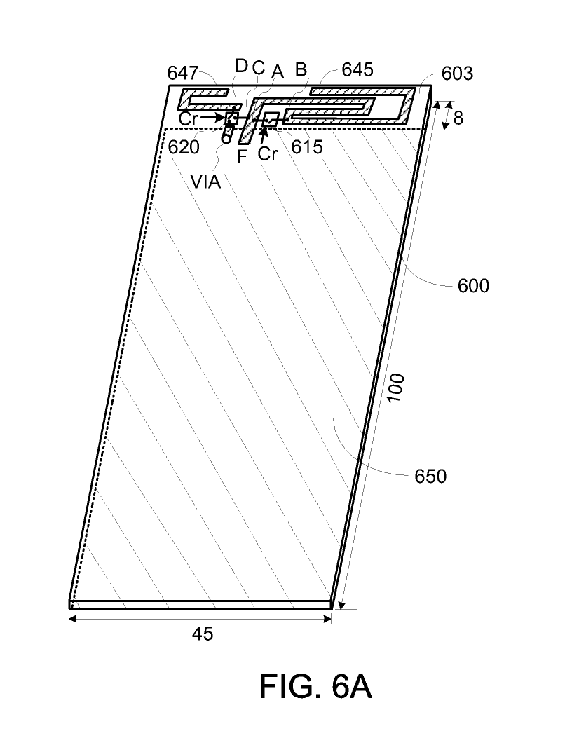

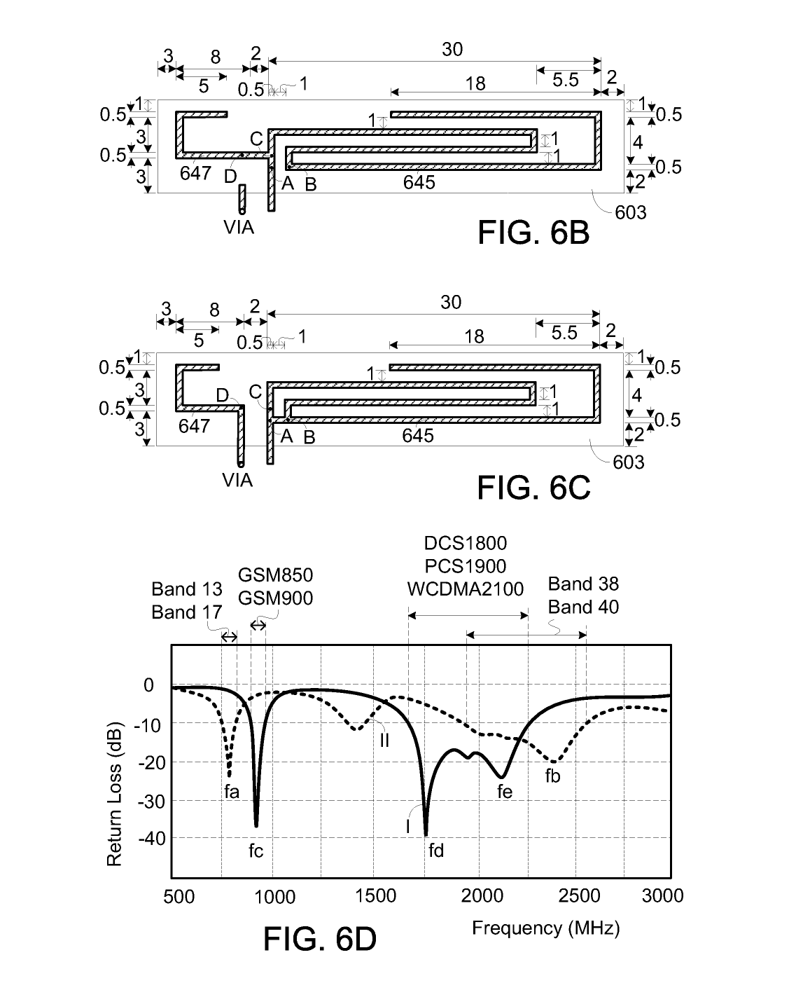

FIG. 6A schematically illustrates the configurations of a frequency-switchable active antenna system according to a second embodiment of the present invention. FIGS. 6B and 6C schematically illustrate two equivalent circuits of the frequency-switchable active antenna system of FIG. 6A in a normal working mode. FIG. 6D schematically illustrates the relationship between the measured return loss and the frequency bandwidth of the frequency-switchable active antenna system of FIG. 6A. The frequency-switchable active antenna system is formed on a printed circuit board 600. The printed circuit board 600 has a length of 100 mm and a width of 45 mm. The printed circuit board 600 has an antenna clearance region 603 with a length of 45 mm and a width of 8 mm. An antenna radiation element 645 and a parasitic element 647 are included in the antenna clearance region 603. The antenna radiation element 645 has a feed port at a position F. Moreover, a line width of the antenna radiation element 645 is 0.5 mm, and a line width of the parasitic element 647 is also 0.5 mm. The other dimensions will be illustrated with reference to FIGS. 6B and 6C.

Moreover, a metal ground surface 650 is formed on a bottom layer of the printed circuit board 600 and outside the antenna clearance region 603. The metal ground surface 650 has a length of 92 mm and a width of 45 mm. The feed port position F is disposed on a top layer of the printed circuit board 600, and disposed over the metal ground surface 650.

The antenna radiation element 645 has three different physical positions A, B and C. The parasitic element 647 has a physical position D. The frequency-switchable active antenna system further comprises a switching circuit 615 and single-pole-double-throw (SPDT) switching circuit 620. A first terminal of the switching circuit 615 is connected with the physical position A. A second terminal of the switching circuit 615 is connected with the physical position B. Moreover, a control terminal of the switching circuit 615 receives a control signal Cr, so that the switching circuit 615 is controlled by the control signal Cr. According to the control signal Cr, the switching circuit 615 is selectively in a close state or an open state. The single-pole terminal of the SPDT switching circuit 620 is connected with the physical position D. One double-throw terminal of the SPDT switching circuit 620 is connected with the physical position C. The other double-throw terminal of the SPDT switching circuit 620 is connected with the metal ground surface 650 through a via. According to the control signal Cr, the SPDT switching circuit 620 is selectively in a first switching state or a second switching state.

In the frequency-switchable active antenna system of the second embodiment, the antenna radiation element 645 is not connected with the metal ground surface 650. Moreover, the switching circuit 615 may be selectively in a close state or an open state, and the SPDT switching circuit 620 may be selectively in the first switching state or the second switching state. In the first switching state of the SPDT switching circuit 620, the physical position D and the physical position C are electrically connected with each other. In the second switching state of the SPDT switching circuit 620, the physical position D is connected with the metal ground surface 650 through the via.

As shown in FIG. 6B, the switching circuit 615 is in the open state. Under this circumstance, the two physical positions A and B are not connected with each other through the switching circuit 615. In addition, the SPDT switching circuit 620 is in the first switching state. In the first switching state of the SPDT switching circuit 620, the physical position D and the physical position C are electrically connected with each other. Consequently, the antenna radiation element 645 resonates at a lower first resonant frequency fa (about 700 MHz), and the parasitic element 647 resonates at a higher second resonant frequency fb (about 2300-2620 MHz). As shown in the dotted curve II of FIG. 6D, the bandwidth of the antenna system covers the 700 MHz frequency band (Band 13 and Band 17) and 2300-2620 MHz frequency band (Band 38 and Band 40) according to the 4G mobile communication standards.

As shown in FIG. 6C, the switching circuit 615 is in the close state. Under this circumstance, the two physical positions A and B are connected with each other through the switching circuit 615. Consequently, the antenna radiation element 645 has two shorter radiation path lengths. The two radiation path lengths resonate at a third resonant frequency fc and a fourth resonant frequency fd, respectively. The third resonant frequency fc and the fourth resonant frequency fd are higher than 700 MHz. The third resonant frequency fc covers the frequency bands GSM850 and GSM900. The fourth resonant frequency fd is within the frequency band DCS1800. In addition, the SPDT switching circuit 620 is in the second switching state. In the second switching state of the SPDT switching circuit 620, the physical position D is connected with the metal ground surface 650 through the via. Consequently, the parasitic element 647 resonates at a fifth resonant frequency fe. The fifth resonant frequency fe covers the frequency bands PCS1900 and WCDMA2100. The solid curve I of FIG. 6D denotes the result of the measured return loss of the antenna system in the normal working mode of FIG. 6C. As shown in the solid curve I of FIG. 6D, the bandwidth of the antenna system covers the frequency bands GSM850, GSM900, DCS1800, PCS1900 and WCDMA2100.

From the above discussions about the second embodiment, the switching circuit 615 is selectively in the open state or the close state. In case that the switching circuit 615 is the open state, the first resonance frequency fa of the antenna radiation element 645 covers the 700 MHz frequency band (Band 13 and Band 17) according to the 4G mobile communication standards. Whereas, in case that the switching circuit 615 is the close state, the third resonance frequency fc and the fourth resonance frequency fd of the antenna radiation element 645 cover the frequency bands GSM850, GSM900 and DCS1800. All of these resonant frequencies are higher than 700 MHz.

Moreover, when the SPDT switching circuit 620 is switched between the first switching state and the second switching state, the second resonant frequency fb of the parasitic element 647 may cover the 2300-2620 MHz frequency band (Band 38 and Band 40) or the fifth resonance frequency fe of the parasitic element 647 may cover the frequency bands PCS1900 and WCDMA2100.

In the second embodiment, when the switching circuit 615 is switched between the open state and the close state, the radiation path length of the antenna radiation element 645 is correspondingly changed. Moreover, when the SPDT switching circuit 620 is switched between the first switching state and the second switching state, the parasitic element 647 also can resonate at different resonant frequencies. Consequently, if the dimensions of the antenna radiation element 645 and the parasitic element 647 are properly adjusted, the bandwidth of the antenna system may cover the frequency bands Band 13/17/38/40, GSM850, GSM900, DCS1800, PCS1900 and WCDMA2100.

In the second embodiment, the two switching circuits (i.e. the switching circuit 615 and the SPDT switching circuit 620) are controlled according to a single control signal Cr. Of course, the two switching circuits may be controlled according to two control signals, respectively.

It is noted that numerous modifications and alterations may be made while retaining the teachings of the invention. For example, in a third embodiment of the present invention, the switching circuit 615 of the second embodiment may be omitted, and the physical positions A and B are connected with each other through a conductor. Under this circumstance, the physical position D is selectively connected with the physical position C or the metal ground surface through the SPDT switching circuit. Moreover, the conductor between the physical positions A and B is a conductive metal line or a conductive metal plate.

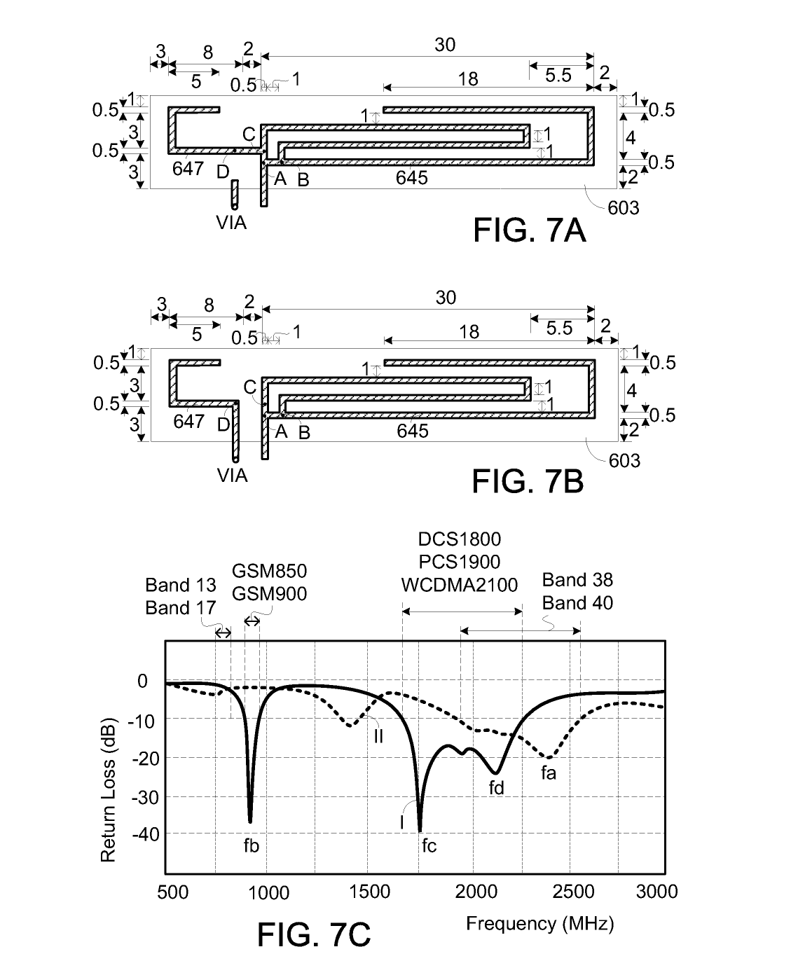

FIGS. 7A and 7B schematically illustrates schematically illustrate two equivalent circuits of a frequency-switchable active antenna system in a normal working mode according to a third embodiment of the present invention. FIG. 7C schematically illustrates the relationship between the measured return loss and the frequency bandwidth of the frequency-switchable active antenna system of the third embodiment.

As shown in FIG. 7A, the SPDT switching circuit is in the first switching state. In the first switching state of the SPDT switching circuit, the physical position D and the physical position C are electrically connected with each other. Consequently, the parasitic element 647 resonates at a higher first resonant frequency fa. As shown in the dotted curve II of FIG. 7C, the first resonance frequency fa covers the 2300-2620 MHz frequency band (Band 38 and Band 40). In comparison with the dotted curve II of FIG. 6D, the bandwidth of the antenna system of the third embodiment does not cover the 700 MHz frequency band (Band 13 and Band 17) according to the 4G mobile communication standards.

As shown in FIG. 7B, the SPDT switching circuit is in the second switching state. In the second switching state of the SPDT switching circuit, the physical position D is connected with the metal ground surface through the via. The antenna radiation element 645 has two shorter radiation path lengths. The solid curve I of FIG. 7C denotes the result of the measured return loss of the antenna system in the normal working mode of FIG. 7B. The two radiation path lengths resonate at a second resonant frequency fb and a third resonant frequency fc, respectively. The second resonant frequency fb covers the frequency bands GSM850 and GSM900. The third resonant frequency fc covers the frequency band DCS1800. Moreover, the parasitic element 647 also resonates at a fourth resonant frequency fd. The fourth resonant frequency fd covers the frequency bands PCS1900 and WCDMA2100. As shown in the solid curve I of FIG. 7C, the bandwidth of the antenna system covers the frequency bands GSM850, GSM900, DCS1800, PCS1900 and WCDMA2100.

In the third embodiment, the SPDT switching circuit is switched between the first switching state and the second switching state. Consequently, when the radiation path lengths are further properly adjusted, under this circumstance, the bandwidth of the antenna system may cover the frequency bands Band 38/40, GSM850, GSM900, DCS1800, PCS1900 and WCDMA2100.

From the above discussions about the third embodiment, the physical positions A and B are connected with each other through a conductor. Moreover, the frequency bands of the antenna system may be adjusted by switching the SPDT switching circuit.

It is noted that the active antenna system of the third embodiment may be modified. In another embodiment, an end of the conductor is connected with the physical position A of the antenna radiation element 645, but the other end of the conductor is not connected with the physical position B of the antenna radiation element 645. When the SPDT switching circuit is switched between the first switching state and the second switching state, the radiation path lengths may be further properly changed. Consequently, the antenna system may resonate at various resonant frequencies.

From the above descriptions, the present invention provides a frequency-switchable active antenna system. The active antenna system can be easily fabricated. Moreover, the complexity of designing and controlling the active antenna system is largely reduced. Moreover, by means of changing the status of the switching circuit, the radiation path lengths of the antenna radiation element may be changed, the resonant frequency of the active antenna system can be correspondingly switched. Consequently, the bandwidth of the active antenna system can cover more frequency bands. Moreover, the antenna size of the active antenna system is reduced.

Moreover, the verification results of the second embodiment indicate that the antenna bandwidth of the fourth generation mobile antenna can cover all of the 2G/3G/4G frequency bands while achieving good impedance matching efficacy. Moreover, the complexity of designing the active antenna system is largely reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An active antenna system, comprising:
a printed circuit board having an antenna clearance region;
an antenna radiation element having a feed port, a first physical position and a second physical position;
a metal ground surface formed on a first layer of the printed circuit board and outside the antenna clearance region; and
a first switching circuit, wherein a first terminal of the first switching circuit is connected to the first physical position, a second terminal of the first switching circuit is connected to the second physical position, and a control terminal of the first switching circuit receives a first control signal, wherein the first physical position and the second physical position are selectively connected with each other or disconnected from each other according to the first control signal.

2. The active antenna system as claimed in claim 1, wherein the first physical position and the second physical position are included in the antenna clearance region.

3. The active antenna system as claimed in claim 1, wherein the feed port is formed on a second layer of the printed circuit board and outside the antenna clearance region, and the feed port is disposed over the metal ground surface.

4. The active antenna system as claimed in claim 1, wherein if the first physical position and the second physical position are not connected with each other through the first switching circuit, the antenna radiation element resonates at a first resonant frequency.

5. The active antenna system as claimed in claim 4, wherein if the first physical position and the second physical position are connected with each other through the first switching circuit, the antenna radiation element resonates at a second resonant frequency and a third resonant frequency, wherein the second resonant frequency and the third resonant frequency are higher than the first resonant frequency.

6. The active antenna system as claimed in claim 1, wherein the antenna radiation element further comprises a third physical position, and the active antenna system further comprises:
a parasitic element comprising a fourth physical position; and
a second switching circuit, wherein a first terminal of the first second switching circuit is connected to the fourth physical position, a second terminal of the second switching circuit is connected to the third physical position, a third terminal of the second switching circuit is connected to the metal ground surface, and a control terminal of the second switching circuit receives a second control signal, wherein according to the second control signal, the fourth physical position and the third physical position are connected with each other through the second switching circuit or the fourth physical position and the metal ground surface are connected with each other through the second switching circuit.

7. The active antenna system as claimed in claim 6, wherein the third physical position and the fourth physical position are included in the antenna clearance region of the printed circuit board.

8. The active antenna system as claimed in claim 6, wherein if the first physical position and the second physical position are not connected with each other through the first switching circuit but the fourth physical position and the third physical position are connected with each other through the second switching circuit, the antenna radiation element and the parasitic element resonate at a first resonant frequency and a second resonant frequency.

9. The active antenna system as claimed in claim 8, wherein if the first physical position and the second physical position are connected with each other through the first switching circuit and the fourth physical position and the metal ground surface are connected with each other through the second switching circuit, the antenna radiation element and the parasitic element resonate at a third resonant frequency, a fourth resonant frequency and a fifth resonant frequency, wherein all of the third resonant frequency, the fourth resonant frequency and the fifth resonant frequency are higher than the first resonant frequency and lower than the second resonant frequency.

10. A control method of an active antenna system, the active antenna system comprising an antenna radiation element and a first switching circuit, the antenna radiation element having a feed port, a first physical position and a second physical position, a first terminal of the first switching circuit being connected to the first physical position, a second terminal of the first switching circuit being connected to the second physical position, the control method comprising steps of:
providing a control signal to the first switching circuit;
if the first physical position and the second physical position are not connected with each other through the first switching circuit according to the control signal, the antenna radiation element resonating at a first resonant frequency; and
if the first physical position and the second physical position are connected with each other through the first switching circuit according to the control signal, the antenna radiation element resonating at a second resonant frequency and a third resonant frequency,
wherein the second resonant frequency and the third resonant frequency are higher than the first resonant frequency.

11. The control method as claimed in claim 10, wherein the antenna radiation element further comprises a third physical position, and the active antenna system further comprises a parasitic element and a second switching circuit, wherein the parasitic element has a fourth physical position, a first terminal of the second switching circuit is connected to the fourth physical position, a second terminal of the second switching circuit is connected to the third physical position, and a third terminal of the second switching circuit is connected to a metal ground surface, wherein the control method further comprises steps of:
if the first physical position and the second physical position are not connected with each other through the first switching circuit but the fourth physical position and the third physical position are connected with each other through the second switching circuit, the antenna radiation element and the parasitic element resonate at the first resonant frequency and a fourth resonant frequency; and
if the first physical position and the second physical position are connected with each other through the first switching circuit and the fourth physical position and the metal ground surface are connected with each other through the second switching circuit, the antenna radiation element and the parasitic element resonate at the second resonant frequency, the third resonant frequency and a fifth resonant frequency,
wherein all of the second resonant frequency, the third resonant frequency and the fifth resonant frequency are higher than the first resonant frequency and lower than the fourth resonant frequency.

12. An active antenna system, comprising:
a printed circuit board having an antenna clearance region;
an antenna radiation element comprising a feed port, a first physical position and a second physical position;
a conductor connected to the first physical position;
a metal ground surface formed on a first layer of the printed circuit board and outside the antenna clearance region;
a parasitic element comprising a third physical position; and
a switching circuit, wherein a first terminal of the switching circuit is connected to the third physical position, a second terminal of the switching circuit is connected to the second physical position, a third terminal of the switching circuit is connected to the metal ground surface, and a control terminal of the switching circuit receives a control signal, wherein according to the control signal, the third physical position and the second physical position are connected with each other through the switching circuit or the third physical position and the metal ground surface are connected with each other through the switching circuit.

13. The active antenna system as claimed in claim 12, wherein the antenna radiation element further comprises a fourth physical position, wherein the first physical position and the fourth physical position are connected with each other through the conductor.

14. The active antenna system as claimed in claim 13, wherein the first physical position, the second physical position, the third physical position and the fourth physical position are included in the antenna clearance region of the printed circuit board.

15. The active antenna system as claimed in claim 13, wherein if the second physical position and the third physical position are connected with each other through the switching circuit, the antenna radiation element and the parasitic element resonate at a first resonant frequency.

16. The active antenna system as claimed in claim 15, wherein if the third physical position and the metal ground surface are connected with each other through the switching circuit, the antenna radiation element and the parasitic element resonate at a second resonant frequency, a third resonant frequency and a fourth resonant frequency, wherein all of the second resonant frequency, the third resonant frequency and the fourth resonant frequency are lower than the first resonant frequency.
